(19) United States
(12) Patent Application Publication
(10) Pub. No.: US 2019/0073908 A1
(43) Pub. Date: Mar. 7, 2019

(54) COOPERATIVE VEHICLE OPERATION

(71) Applicant: Ford Global Technologies, LLC, Dearborn, MI (US)

(72) Inventors: Cynthia M. Neubecker, Westland, MI (US); Somak Datta Gupta, Novi, MI (US); Mahmoud Yousef Ghannam, Canton, MI (US); Cheri Lyn Hansen, Canton, MI (US)

(73) Assignee: Ford Global Technologies, LLC, Dearborn, MI (US)

(21) Appl. No.: 15/695,664

(22) Filed: Sep. 5, 2017

(51) Int. Cl. G08G 1/00; G05D 1/00

(52) U.S. Cl. CPC G08G 1/22; G05D 2201/0213; G05D 1/0061; G05D 1/0088

(57) ABSTRACT

A computing device is programmed to form a platoon with a second vehicle upon determining a fault in sensor data in a first vehicle. The computer can be further programmed to clean a sensor associated with the fault while platooning with the second vehicle including receiving substitute sensor data from the second vehicle.

### BACKGROUND

Vehicles can be equipped to operate in both autonomous and occupant piloted mode. Vehicles can be equipped with computing devices, networks, sensors and controllers to acquire information regarding the vehicle's environment and to pilot the vehicle based on the information. Safe and comfortable piloting of the vehicle can depend upon acquiring accurate and timely information regarding the vehicles' environment. Computing devices, networks, sensors and controllers can be equipped to analyze their performance, detect when information is not being acquired in an accurate and timely fashion, and take corrective actions including informing an occupant of the vehicle, relinquishing autonomous control or parking the vehicle.

### BRIEF DESCRIPTION OF THE DRAWINGS

FIG. 1 is a block diagram of an example vehicle.

FIG. 2 is a diagram of an example vehicle with a sensor.

FIG. 3 is a diagram of an examples of sensor output data.

FIG. 4 is a diagram of example vehicles platooning.

FIG. 5 is a flowchart diagram of an example process to determine and correct sensor faults.

FIG. 6 is a flowchart diagram of an example process to determine and correct sensor faults with two vehicles.

FIG. 7 is a flowchart diagram of an example process to determine and correct sensor faults with two vehicles.

### DETAILED DESCRIPTION

Vehicles can be equipped to operate in both autonomous and occupant piloted mode. By a semi- or fully-autonomous mode, we mean a mode of operation wherein a vehicle can be piloted by a computing device as part of a vehicle information system having sensors and controllers. The vehicle can be occupied or unoccupied, but in either case the vehicle can be piloted without assistance of an occupant. For purposes of this disclosure, an autonomous mode is defined as one in which each of vehicle propulsion (e.g., via a powertrain including an internal combustion engine and/or electric motor), braking, and steering are controlled by one or more vehicle computers; in a semi-autonomous mode the vehicle computer(s) control(s) one or two of vehicle propulsion, braking, and steering.

Disclosed herein is a method, comprising, in a first vehicle, upon determining a fault in sensor data in the first vehicle, forming a platoon with a second vehicle, and, while platooning with the second vehicle, including receiving substitute sensor data from the vehicle, cleaning a first vehicle sensor associated with the fault. The fault can be determined by portions of small or zero value data points or pixels in sensor data. The first vehicle can request and receive permission to platoon by communicating with the second vehicle via vehicle-to-vehicle communications. Substitute sensor data can include the distance between the first vehicle and the second vehicle. Cleaning the sensor can include at least one of washing and mechanically wiping. Unsuccessful sensor cleaning can be determined by small or zero value data points or pixels in sensor data.

The first vehicle can receive directions from the second vehicle to safely park the vehicle. Cleaning the first vehicle sensor can be performed by the second vehicle. The platoon can be formed with the second vehicle in front of the vehicle and a third vehicle behind the vehicle. Cleaning the first vehicle sensor can be performed by the third vehicle. The platoon can be formed with a second vehicle by following the second vehicle at a distance. Following the second vehicle at a distance can be performed using substitute sensor data. The vehicle can receive directions from map data to safely park the vehicle, wherein map data is received via a vehicle-to-infrastructure network interface.

Further disclosed is a computer readable medium, storing program instructions for executing some or all of the above method steps. Further disclosed is a computer programmed for executing some or all of the above method steps, including a computer apparatus, programmed to, in a first vehicle, upon determining a fault in sensor data in the first vehicle, form a platoon with a second vehicle, and, while platooning with the second vehicle, receive substitute sensor data from the vehicle, clean a first vehicle sensor associated with the fault. The fault can be determined by portions of small or zero value data points or pixels in sensor data. The computer apparatus can be further programmed to request and receive permission to platoon by communicating with the second vehicle via vehicle-to-vehicle communications. Substitute sensor data can include the distance between the first vehicle and the second vehicle. Cleaning the sensor can include at least one of washing and mechanically wiping. Unsuccessful sensor cleaning can be determined by small or zero value data points or pixels in sensor data.

The computer apparatus can be further programmed to receive directions from the second vehicle to safely park the vehicle. Cleaning the first vehicle sensor can be performed by the second vehicle. The platoon can be formed with the second vehicle in front of the vehicle and a third vehicle behind the vehicle. Cleaning the first vehicle sensor can be performed by the third vehicle. The computer apparatus can be further programmed to form a platoon with a second vehicle by following the second vehicle at a distance. Following the second vehicle at a distance can be performed using substitute sensor data. The vehicle can receive directions from map data to safely park the vehicle, wherein map data is received via a vehicle-to-infrastructure network interface.

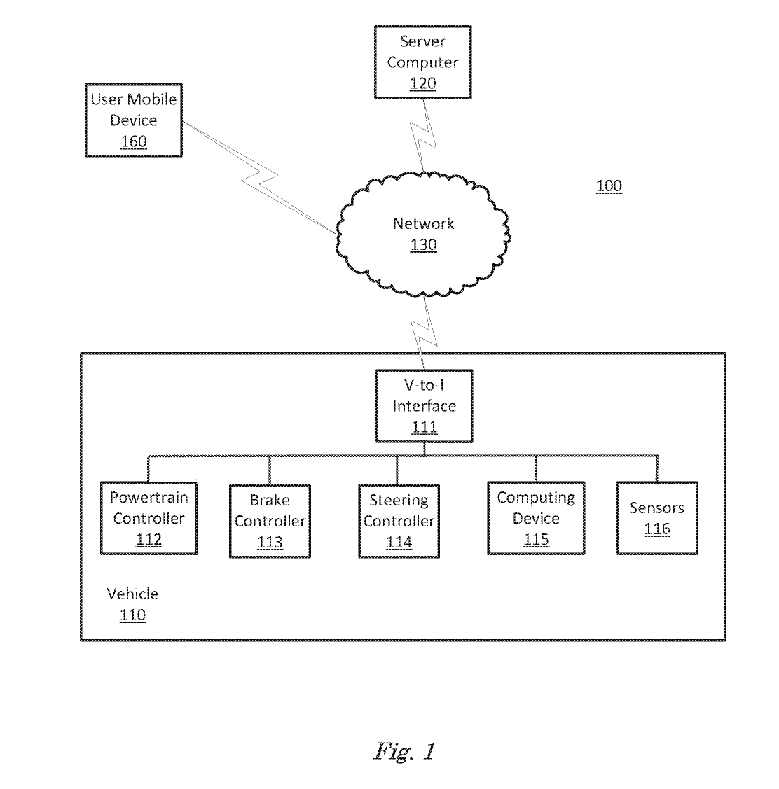

FIG. 1 is a diagram of a vehicle information system 100 that includes a vehicle 110 operable in autonomous (“autonomous” by itself in this disclosure means “fully autonomous”) and occupant piloted (also referred to as non-autonomous) mode in accordance with disclosed implementations. Vehicle 110 also includes one or more computing devices 115 for performing computations for piloting the vehicle 110 during autonomous operation. Computing devices 115 can receive information regarding the operation of the vehicle from sensors 116.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (e.g., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, e.g., via a vehicle communications bus as described further below, more than one computing devices, e.g., controllers or the like included in the vehicle 110 for monitoring and/or controlling various vehicle components, e.g., a powertrain controller 112, a brake controller 113, a steering controller 114, etc. The computing device 115 is generally arranged for communications on a vehicle communication network such as a bus in the vehicle 110 such as a controller area network (CAN) or the like; the vehicle 110 network can include wired or wireless communication mechanism such as are known, e.g., Ethernet or other communication protocols.

Via the vehicle network, the computing device 115 may transmit messages to various devices in the vehicle and/or receive messages from the various devices, e.g., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V-to-I) interface 111 with a remote server computer 120, e.g., a cloud server, via a network 130, which, as described below, may utilize various wired and/or wireless networking technologies, e.g., cellular, BLUETOOTH® and wired and/or wireless packet networks. Computing device 115 may be configured for communicating with other vehicles 110 through V-to-I interface 111 using vehicle-to-vehicle (V-to-V) networks formed on an ad hoc basis among nearby vehicles 110 or formed through infrastructure-based networks. The computing device 115 also includes nonvolatile memory such as is known. Computing device 115 can log information by storing the information in nonvolatile memory for later retrieval and transmittal via the vehicle communication network and a vehicle to infrastructure (V-to-I) interface 111 to a server computer 120 or user mobile device 160.

As already mentioned, generally included in instructions stored in the memory and executed by the processor of the computing device 115 is programming for operating one or more vehicle 110 components, e.g., braking, steering, propulsion, etc., without intervention of a human operator. Using data received in the computing device 115, e.g., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors such as speed, acceleration, deceleration, steering, etc., as well as tactical behaviors such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113 and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computer 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously.

The vehicle 110 is generally a land-based autonomous vehicle 110 having three or more wheels, e.g., a passenger car, light truck, etc. The vehicle 110 includes one or more sensors 116, the V-to-I interface 111, the computing device 115 and one or more controllers 112, 113, 114.

The sensors 116 may be programmed to collect data related to the vehicle 110 and the environment in which the vehicle 110 is operating. By way of example, and not limitation, sensors 116 may include, e.g., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating such as weather conditions, the grade of a road, the location of a road or locations of neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components and electrical and logical health of the vehicle 110.

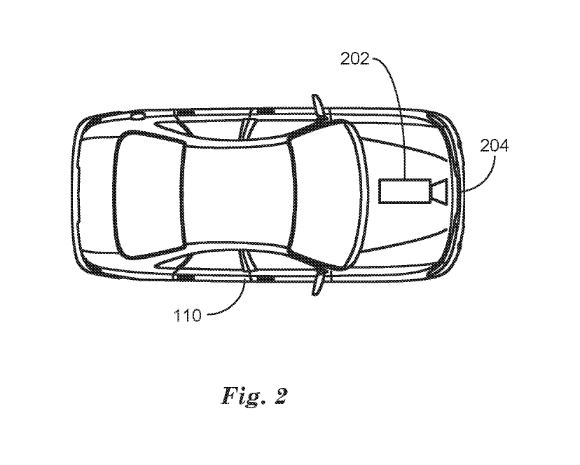

FIG. 2 is a diagram of a vehicle 110 configured with a video camera 202 as one of the sensors 116. As discussed above, a vehicle 110 can have a variety of sensors 116, including video cameras, radar sensors, LIDAR sensors, and the like to acquire information regarding the environment external to the vehicle 110 and permit a computing device 115 to pilot vehicle 110 or assist an occupant in piloting a vehicle 110. Sensors 116, like video camera 202, can be housed in portions of a vehicle 110 body and covered by a protective window 204 made of plastic or glass that protects the sensor 116 from road hazards, like rocks, or weather, like rain or snow but permit light or radar waves to reach the sensor 116. A sensor 116 can also be housed in a “pod” or external housing attached to a roof portion of vehicle 110, for example, where the pod or external housing can have a glass or plastic protective window to permit the sensor 116 to receive light or radar waves.

In examples where sensor 116 data is being used by computing device 115 to pilot a vehicle 110, the computing device 115 can require that the sensor 116 data have a predetermined minimum percentage usable, or non-obscured portion of the field of view. A sensor 116 can determine the percentage of usable, or non-obscured data points from a sensor 116 output by determining the percentage of non-zero data points or pixels output by sensor 116. Output of data points or pixel with value equal zero can mean that no detectable signal was received in a portion of the field of view of sensor 116, and therefore the portions of protective window 204 covering the sensor 116 associated with the zero value data points or pixels can be obscured by foreign substance like dirt, mud, snow, or ice, etc. on protective window 204 that covers a sensor 116. Zero value data points or pixels in output from a sensor 116 can be associated with portions of protective window 204 by intersecting the field of view of a sensor 116 with the physical shape of protective window 204, for example.

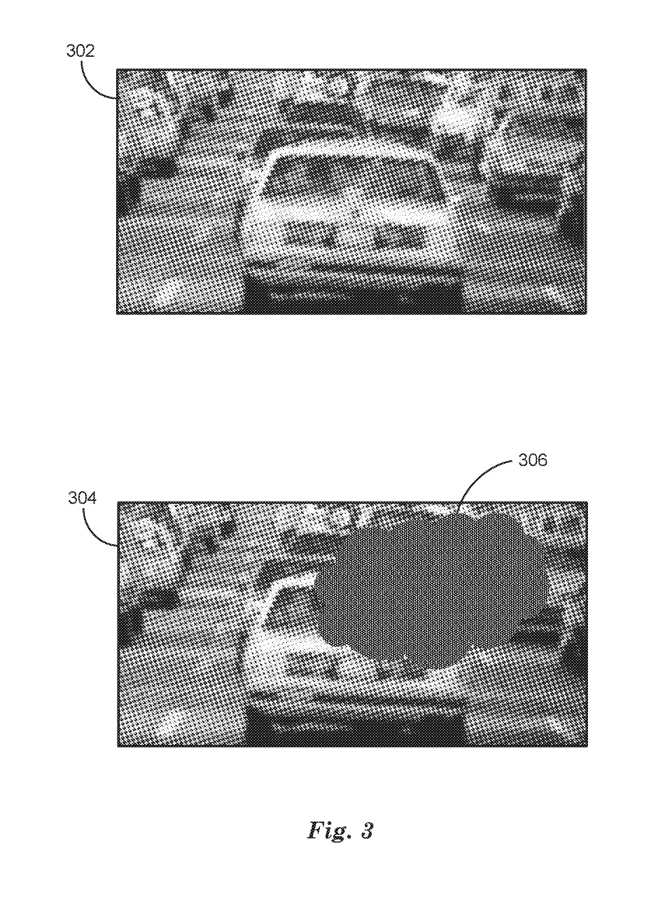

FIG. 3 is a diagram of example video images 302, 304 acquired by video camera 202 through a protective window 204. In video image 302, video camera 202 has a clear view of a traffic scene in front of vehicle 110. In video image 304, the view through protective window 204 has been compromised by a foreign substance, such as dirt, mud, snow, or ice, etc. and video image 304 includes an obscured portion 306. Obscured portion 306 can be detected by computing device 115 because obscured portion 306 will be represented by small or zero value pixels in video image 304. A obscured portion 306 of video images that has a small or zero value that occupies more than a predetermined minimum area of video image 304, can indicate a foreign substance on the protective window 204, whereupon the computing device 115 can be programmed to determine that the sensor 116 is operating at less than the predetermined percentage of usable, or non-obscured portions required for use in the piloting of vehicle 110. In examples where a sensor 116 is required by computing device 115 for safe piloting of vehicle 110, if the percentage of usable portions of sensor 116 is less than a predetermined minimum, for example 99%, computing device 115 can be programmed to park vehicle 110 in an available safe parking location

In a similar fashion, LIDAR and radar images acquired through a protective window 204 can indicate foreign substances on the protective window 204 by determining constant or missing data. For example, LIDAR and radar images represent distances from the sensor 116 to objects in the field of view. If portions of the LIDAR or radar images acquired by computing device 115 consistently indicate constant or missing data from image to image, computing device 115 can determine that portions of the protective window 204 covering the LIDAR or radar sensor can be obscured by a foreign substance. Determining that LIDAR or radar images include constant or missing data that occupies more than a predetermined minimum area of the LIDAR or radar image can indicate a foreign substance on the protective window 204 whereupon the computing device 115 can be programmed to determine that sensor 116 is operating at less than the predetermined percentage of usable portions required for safe piloting of vehicle 110.

In examples where computing device 115 determines that a sensor 116 is operating at less than the predetermined probability usable portions, computing device 115 can implement steps to address the situation. Protective window 204 covering a sensor 116 can be equipped with washer nozzles that spray water or cleaning fluid on the window and mechanical devices like wipers to wipe the window clean and remove foreign substances. These spray nozzles and mechanical wipers can be similar to spray nozzles and mechanical wipers commonly used to clean windshields on a vehicle 110. Computing device 115 can direct a spray of cleaning fluid and direct a mechanical wiper to clean the protective window. If washing and wiping corrects the problem and the sensor 116 can return to operating at the predetermined required probability (or greater) of usable portions. In this example, computing device 115 has corrected the problem and can resume safe operation of vehicle 110 based on sensor 116 data. If computing device 115 does not determine that sensor 116 has returned to operating with a predetermined required probability of usable portions by determining that the data no longer has obscured portions 306 of constant or missing data, computing device 115 can determine that sensor 116 can have a problem that cannot be remedied by washing and wiping. If computing device 115 determines that washing and wiping do not correct the problem, computing device 115 can determine that a problem exits in sensor 116 that cannot be remedied by cleaning the protective window 204, and computing device 115 therefore cannot rely on sensor 116 to supply data that can be used for safe piloting of vehicle 110.

To avoid piloting vehicle 110 in an unsafe fashion, computing device 115 can immediately pilot vehicle 110 off the roadway to park in an available safe parking location while the protective window 204 is being cleaned. A safe parking location is a location in which a vehicle 110 can park without interfering with roadway traffic, i.e. other vehicles, for example. Safe locations to park vehicle 110 can include parking locations along or adjacent to the roadway where vehicle 110 can park and await service. Safe parking locations can include locations predetermined and stored at computing device 115 based on a maps and vehicle 110 location. Computing device 115 can pilot vehicle 110 to a safe parking locations by determining a path to the safe parking location based on vehicle's 110 location on a predetermined map using sensors 116 like accelerometers and GPS. When vehicle 110 is directed to park by computing device 115, vehicle 110 can communicate with a server computer 120 via V-to-I interface 111 to alert appropriate authorities that vehicle 110 requires assistance and/or service. This can include sending another vehicle to permit occupants to continue traveling their destination, and dispatching a service or tow vehicle to service or tow vehicle 110, for example.

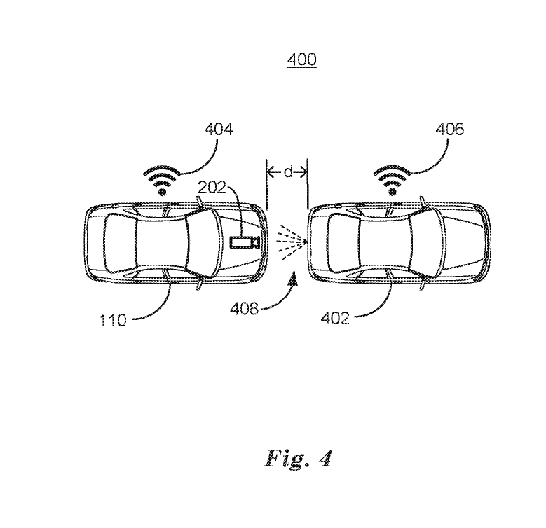

FIG. 4 is a diagram of a traffic scene 400, in which vehicle 110 has platooned with a second vehicle 402 while computing device 115 cleans protective window 204. To avoid having to park vehicle 110 while computing device 115 is cleaning protective window 204, computing device 115 can platoon with a second vehicle 402 by communicating with the second vehicle via vehicle-to-vehicle (V-to-V) communications as described above in relation to FIG. 1. Vehicle 110 can communicate via a V-to-V network interface 404, which can be a wireless transceiver to communicate via a short distance network like BLUETOOTH™, a local area network like a Wi-Fi network, or a wide area network like a cellular telephone network. A second vehicle 402 can receive the communications with a similar network interface 406. Vehicle 110 and second vehicle 402 can communicate via V-to-V networking to establish a vehicle platoon, in which vehicle 402 can transmit data to computing device 115 in vehicle 110 to pilot vehicle 110 so at so maintain a distance “d” from second vehicle 402 as they are being piloted.

Platooning is a piloting maneuver wherein vehicle 110 maintains a distance “d” behind a second vehicle 402 while both vehicle 110 and second vehicle 402 are traveling on a roadway. Alternatively or additionally, platooning is a piloting technique whereby the vehicle 110 receives piloting instructions, e.g., regarding speed, steering etc., from a lead vehicle 402. While platooning, a vehicle 110 can use sensor 116 data to determine the distance between vehicle 110 and second vehicle 402 while sensors 116 on second vehicle 402 can determine a path for piloting both vehicle 110 and second vehicle 402. Platooning can permit vehicle 110 and second vehicle 402 to be piloted at higher speeds and at a higher traffic density than if they were piloted independently. Data transmitted from second vehicle 402 to vehicle 110 can include substitute sensor 116 data that substitutes for for incomplete or unreliable data from sensors 116. Substitute sensor 116 data is transmitted from second vehicle 402 and includes the distance “d” between vehicle 110 and vehicle 402 and/or data describing vehicle 110 trajectory, i.e., a speed and heading. Substitute sensor 116 data can be transmitted by vehicle 402 to vehicle 110 until vehicle 110 has cleaned protective window 204 covering sensors 116, including a video camera 202, for example, and computing device 115 has determined that sensor 116 is outputting data that has a predetermined probability or greater of being correct. Substitute sensor 116 data can be used by computing device 115 in vehicle 110 to maintain a distance “d” between vehicle 110 and second vehicle 402 permitting vehicle 110 to continue being piloted safely in spite of incomplete or unreliable data, rather than requiring vehicle 110 to park in an available safe parking location. Vehicle 110 can also communicate with second vehicle 402 regarding the success or failure of cleaning efforts. For example, vehicle 110 can be experiencing a sensor 116 fault that cannot be resolved by cleaning as discussed above. In this example, second vehicle 402 can be configured to include a secondary spray nozzle operative to spray 408 water or cleaning fluid, onto a protective window 204 covering sensors 116 on vehicle 110. Sensors on vehicle 402 can direct the spray 408 onto the appropriate portions of vehicle 110 to clean protective windows covering sensors 116 in vehicle 110.

Computing device 115 in vehicle 110 can monitor the operation of sensors 116, including video camera 202, for example, to determine if cleaning, by either built-in washer sprays or spray 408 from second vehicle 402, has been successful in cleaning protective window 204 over sensor 116 by testing data output from sensor 116 as discussed above in relation to FIG. 3, to determine percentage of usable portions. In examples where computing device 115 determines that cleaning has been successful and sensors 116 are operating with predetermined or greater percentage of usable portions, computing device 115 in vehicle 110 can communicate with second vehicle 402 via V-to-V networking to stop platooning and resume independent control of vehicle 110. In examples where cleaning efforts are unsuccessful and sensors 116 on vehicle 110 are not restored to a predetermined or greater percentage of usable portions required for safe piloting of vehicle 110 can continue platooning with second vehicle 402 by following second vehicle 402 at a distance “d” until computing device 115 in vehicle 110 determines a safe parking location and directs vehicle 110 to park.

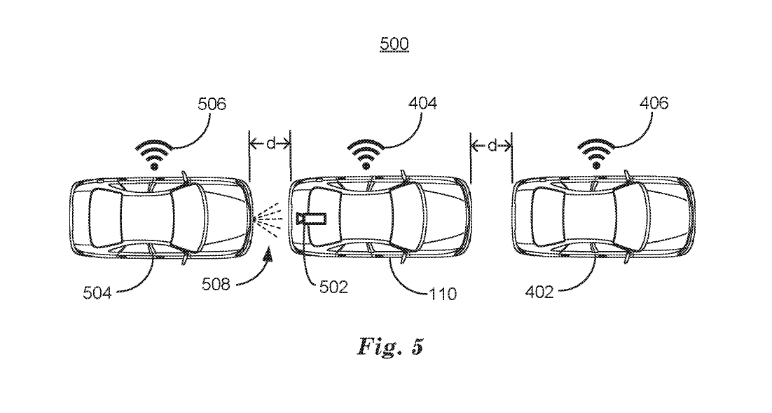

FIG. 5 is a diagram of a traffic scene 500, where vehicle 110 is configured with a sensor 116, in this example a video camera 502, that is configured to be in a rear portion of vehicle 110. In this example, vehicle 110 can communicate via V-to-V network via network interface 404 with network interface 406 on second vehicle 402 and network interface 506 on third vehicle 504 to form a three-car platoon with vehicle 110 in the middle at a distance “d” from both second vehicle 402 and third vehicle 504 as shown in traffic scene 500. In this example, third vehicle 504 can be configured with a spray 508 that can spray cleaning fluid or water onto protective glass covering video camera 502 on vehicle 110 to clean the protective glass and restore video camera 502 to operation with a predetermined or greater percentage of usable portions. As discussed above in relation to FIG. 3, if the cleaning operation is determined to be successful by computing device 115 in vehicle 110, computing device 115 in vehicle 110 can resume independent piloting of vehicle 110 and stop platooning with second vehicle 402 and third vehicle 504. In examples where a cleaning operation is unsuccessful, vehicle 110 can continue to platoon with second vehicle 402 and third vehicle 504 until a safe parking location can be reached as discussed above in relation to FIG. 4.

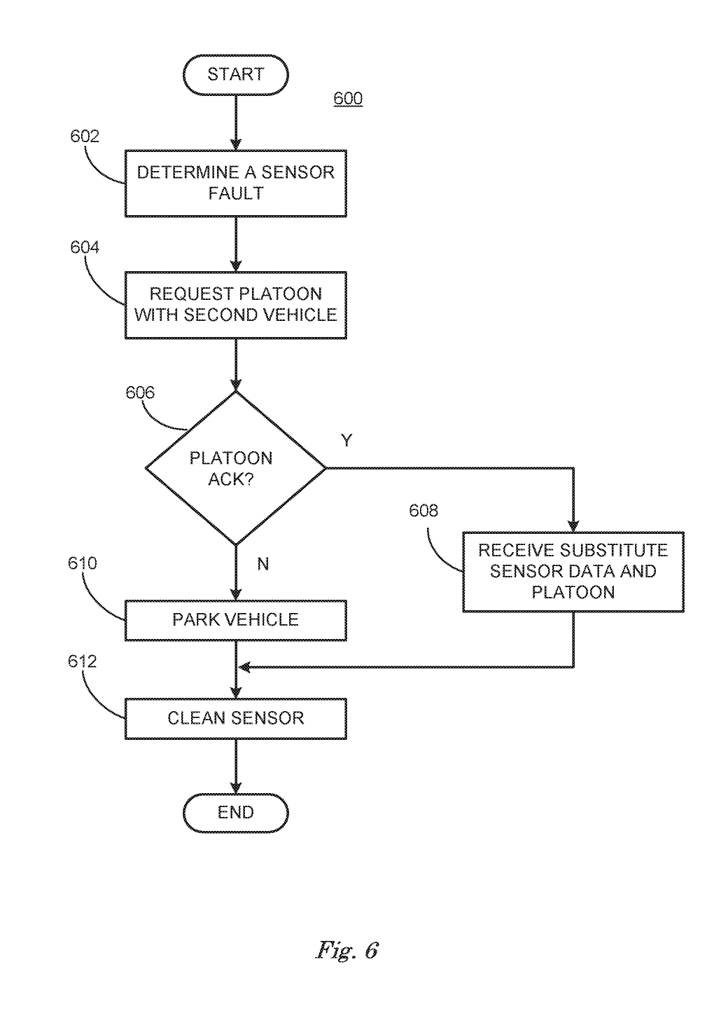

FIG. 6 is a diagram of a flowchart, described in relation to FIGS. 1-4, of a process 600 for correcting a fault in a sensor 116 by cleaning. Process 600 can be implemented by a processor of computing device 115, taking as input information from sensors 116, and executing instructions and sending control signals via controllers 112, 113, 114, for example. Process 600 includes multiple steps taken in the disclosed order. Process 600 also includes implementations including fewer steps or can include the steps taken in different orders.

Process 600 begins at step 602, in which a computing device 115 in a vehicle 110 determines a sensor 116 fault, where computing device 115 determines a sensor 116 is not operating at the predetermined or greater probability of being correct. As discussed above in relation to FIGS. 2 and 3, the presence of a foreign substance on a protective window covering a sensor 116 can cause a sensor 116 fault, where a sensor 116 is determined by computing device 115 to not provide data with a predetermined or greater probability of being correct. As discussed above, when computing device 115 determines a sensor 116 fault, the ability of computing device 115 to pilot a vehicle 110 in a safe manner can be compromised and action can be taken by computing device 115 to insure safe piloting of vehicle 110.

At step 604, computing device 115 can contact a second vehicle 402 via a V-to-V network interface 404, 406 to request a platoon, including a message stating that vehicle 110 had a sensor 116 fault, and was requesting substitute sensor 116 data. In response to the request for a platoon, second vehicle 402 can reply with an acknowledgement (ACK), meaning that second vehicle 402 was prepared to determine and transmit substitute sensor 116 data to permit vehicle 110 to platoon with second vehicle 402, or negative acknowledgment (NAK), meaning that second vehicle 402 was not able or willing to transmit substitute sensor 116 data and permit vehicle 110 to platoon with vehicle 402, to vehicle 110 via a V-to-V network. At step 606 computing device 115 in vehicle 110 can determine whether second vehicle 402 has transmitted a ACK or NAK. If computing device 115 has received an ACK, process 600 branches to step 608.

At step 608, vehicle 402 can transmit substitute sensor 116 data to vehicle 110 via a V-to-V network to permit computing device 115 to pilot vehicle 110 to platoon with second vehicle 402, where platooning with second vehicle 402 includes following second vehicle 402 at a distance “d” based on the substitute sensor 116 data or data describing vehicle 110 trajectory, i.e., a speed and heading. Platooning can permit vehicle 110 and second vehicle 402 to stay within range of a V-to-V network and thereby continue to transmit substitute sensor 116 data to vehicle 110 to permit vehicle 110 to platoon as discussed above in relation to FIG. 4.

Returning to step 606, if vehicle 110 receives a NAK in response to a platoon request in step 604, because a second vehicle 402 is not within V-to-V networking range or where second vehicle 402 is not able or willing to platoon, process 600 branches to step 610, where computing device 115 can direct vehicle 110 to park in an available safe parking location. Computing device 115 can use predetermined map data and vehicle location information to direct vehicle 110 to park in an available safe parking location as discussed above in relation to FIG. 4.

At step 612, vehicle can clean a protective window 204 covering a sensor 116 to remedy a sensor 116 fault. Sensor 116 faults can include a foreign substance covering a portion of the protective window 204. Computing device 115 can direct a washer nozzle and/or a mechanical wiper to wash and wipe the protective window 204 clean. Computing device 115 can test sensor 116 following washing and wiping the protective window 204 clean to determine if the cleaning has remedied the fault by increasing the percentage of usable portions of sensor 116 to a predetermined value or greater, as discussed above in relation to FIG. 3. Following step 612 the process 600 ends.

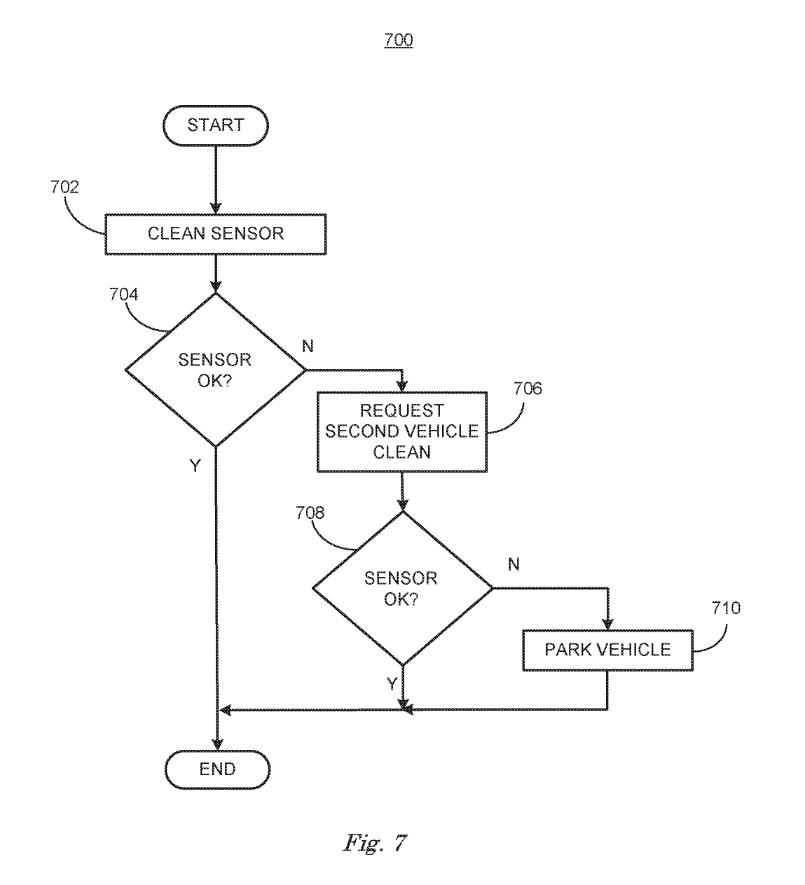

FIG. 7 is a diagram of a flowchart, described in relation to FIGS. 1-4, of a process 700 for correcting a fault in a sensor 116 by cleaning. Process 700 can be implemented by a processor of computing device 115, taking as input information from sensors 116, and executing instructions and sending control signals via controllers 112, 113, 114, for example. Process 700 includes multiple steps taken in the disclosed order. Process 700 also includes implementations including fewer steps or can include the steps taken in different orders.

Process 700 can occur as step 612 of process 600, for example, and begins at step 702. At step 702, computing device 115 can direct a washer nozzle and/or mechanical wiper to clean a protective window 204 associated with sensor 116 as discussed above in relation to FIGS. 2, 3 and 6. At step 704, computing device 115 can evaluate the sensor 116, e.g., as described above, to determine if protective window 204 covering sensor 116 is clean, and data output from sensor 116 has a predetermined or greater percentage of usable portions. If data output from sensor 116 has a predetermined or greater percentage of usable portions, process 700 can end. If data output from sensor 116 does not have a predetermined or greater percentage of usable portions following cleaning, process 600 can branch to step 606. This can happen in examples where a spray nozzle on vehicle 110 is out of fluid or is clogged or frozen, for example.

At step 606, computing device 115 in vehicle 110 can transmit a request to a second vehicle 402 via V-to-V networking to have vehicle 402 spray cleaning fluid or water from a washer nozzle configured for that purpose onto the protective window associated with sensor 116 on vehicle 110. The washer nozzle can be configured to permit second vehicle to aim a spray of cleaning fluid or water onto the protective window 204 of vehicle 110 with sufficient volume and force to clean protective window 204 either alone or in cooperation with mechanical wipers on vehicle 110. A video camera and machine vision software and hardware in vehicle 402 can determine the distance and direction to protective window 204 and aim the washer nozzle to direct cleaning fluid or water to clean protective window 204, for example.

At step 708 computing device 115 in vehicle 110 can determine, using techniques discussed above in relation to FIGS. 2 and 3, whether protective window 204 covering sensor 116 is clean and sensor 116 can output data with a predetermined or greater percentage of usable portions. In examples where sensor 116 can output data with a predetermined or greater percentage of usable portions, process 700 can end. In examples where sensor determined by computing device to not output data with a predetermined or greater percentage of usable portions, process 700 can branch to step 710,

At step 710, computing device 115 can direct vehicle 110 to park in an available safe parking location until the sensor 110 can be serviced. Following step 710 process 600 can end.

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored in files and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, e.g., a reference to an “exemplary widget” should be read as simply referring to an example of a widget.

The adverb “approximately” modifying a value or result means that a shape, structure, measurement, value, determination, calculation, etc. may deviate from an exact described geometry, distance, measurement, value, determination, calculation, etc., because of imperfections in materials, machining, manufacturing, sensor measurements, computations, processing time, communications time, etc.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

We claim:

1. A method in a first vehicle, comprising:
upon determining a fault in sensor data in the first vehicle, forming a platoon with a second vehicle; and
while platooning with the second vehicle, including receiving substitute sensor data from the vehicle, cleaning a first vehicle sensor associated with the fault.

2. The method of claim 1, further comprising determining the fault by determining portions of small or zero value data points or pixels in sensor data.

3. The method of claim 1, further comprising requesting and receiving permission to platoon by communicating with the second vehicle via vehicle-to-vehicle communications.

4. The method of claim 1, wherein substitute sensor data includes the distance between the first vehicle and the second vehicle.

5. The method of claim 1, wherein cleaning the sensor includes at least one of washing and mechanically wiping.

6. The method of claim 1, further comprising determining that cleaning the sensor is unsuccessful by determining small or zero value data points or pixels in sensor data.

7. The method of claim 6, further comprising receiving directions from the second vehicle to safely park the vehicle.

8. The method of claim 1, wherein cleaning the first vehicle sensor is performed by the second vehicle.

9. The method of claim 1, further comprising forming the platoon with the second vehicle in front of the vehicle and a third vehicle behind the vehicle.

10. The method of claim 9, wherein cleaning the first vehicle sensor is performed by the third vehicle.

11. A computer apparatus, programmed to:
form a platoon with a second vehicle upon determining a fault in sensor data in a first vehicle; and
clean a sensor associated with the fault while platooning with the second vehicle including receiving substitute sensor data from the second vehicle.

12. The computer of claim 11, further programmed to determine the fault by determining small or zero value data points or pixels in sensor data.

13. The computer of claim 11, further programmed to request and receive permission to platoon with the second vehicle via vehicle-to-vehicle communications.

14. The computer of claim 11, where substitute sensor data includes the distance between the first vehicle and the second vehicle.

15. The computer of claim 11, wherein clean the sensor includes at least one of washing and mechanically wiping.

16. The computer of claim 11, further programmed to determine that clean the sensor is unsuccessful by determining small or zero value data points or pixels in sensor data.

17. The computer of claim 16, further programmed to, when clean the sensor is unsuccessful, receiving directions from the second vehicle to safely park the vehicle.

18. The computer of claim 11, wherein clean the sensor is performed by the second vehicle.

19. The computer of claim 11, further programmed to form the platoon with the second vehicle in front of the vehicle and a third vehicle behind the vehicle.

20. The computer of claim 19, wherein clean the sensor is performed by the third vehicle.
